(19) United States
(12) Patent Application Publication
(10) Pub. No.: US 2015/0356651 A1
(43) Pub. Date: Dec. 10, 2015

(54) Method for group purchasing pricing with dynamic pricing

(71) Applicant: Vernon Nels Pearson, Roscoe, IL (US)

(72) Inventor: Vernon Nels Pearson, Roscoe, IL (US)

(73) Assignee: Vernon Pearson, Roscoe, IL (US)

(21) Appl. No.: 14/301,316

(22) Filed: Jun. 10, 2014

(51) Int. Cl. G06Q 30/06

(52) U.S. Cl. CPC G06Q 30/0605

(57) ABSTRACT

Method pertains to a system of entities that make purchases and interact either synchronously or asynchronously into a group that exercises collective buying power. It provides a process whereby individual entities can enter the group at a specified price and receive a rebate as new entities enter the group. The method is useful because of its transparency, sustainability, and ability to provide economic benefits equitably to all stakeholders and incentives to entities in the group to market the group and recruit individuals to join the group. Move over, the structure of the system improves upon the standard coupon scheme as well as the bid and offer system.

### CROSS-REFERENCE TO RELATED APLLICATIONS

This application claims the benefit of U.S. Provisional Application Ser. No. 61/833,797 filed Jun. 11, 2013.

### FIELD OF THE INVENTION

The invention generally relates to techniques for arbitrage and pricing power in a market. More specifically, it relates to methods that structure individual entities into a group to purchase in volume and economically gain through collective buying power while providing incentives and a manageable and predictable structure for counterparties.

### BACKGROUND OF INVENTION

The general consensus in economic theory is that the structure of an efficient market is defined by the theory of perfect competition. However, markets may not always operate according to the conditions of perfect competition. Some criteria not fulfilled may include: perfect information, zero transaction costs, and non-increasing returns to scale. For instance, companies spend billions of dollars in advertisements to inform the public. It becomes necessary then to structure a market in such a way that limits these inefficiencies by applying technology and structuring the inefficiencies themselves.

With the advance of smartphones and computer technology, it becomes possible to address these issues. Today, people increasingly use smartphones to make purchases via ecommerce, access the Internet while in store to become better informed, and receive discounts through mobile coupons. In fact, the market for ecoupons is important as it is estimated that the number of mobile coupon users will increase from 12.3 million in 2010 to 53.2 million in 2014 (Mobile Spurs Digital Coupon User Growth, eMarketer, http://www.emarketer.com/Article/Mobile-Spurs-Digital-Coupon-User-Growth/1009639#VtDzxL6QcVIG76xo.99, Jan. 31, 2013). The connectivity of the smartphone, whether through social or some other form, has permitted this explosive growth and the growth of companies like Groupon© and LivingSocial©.

Coupons are a rather inefficient market mechanism for both the merchant whose goal it is to increase volume and consumer base and the consumer whose goal it is to decrease the price of an item or service. For the merchant, the coupons may only attract free riders whose goal it is to use the service once at the discounted price and never return. Additionally, time, money and organizational effort must be allocated to run and promote the program. For the consumer, the couponing scheme requires a large investment in the opportunity cost. The time to search, gather and organize the different coupons can be overwhelming. As a result, couponing scheme structures market participants into two segments: those who allocate their time to couponing or the ‘in’ crowd and those who do not or the ‘out’ crowd. The first group usually does it for the emotional benefit of “the deal.” The second group just pays a higher price. Moreover, coupons are usually limited in one manner or another with expiration dates and purchase limits. As a result, the structure itself is inefficient because it rewards people on a ‘know first’ basis and unsustainable because merchants cannot or do not allow an infinite amount of purchases at the prevailing coupon rate. More over, other couponing models may require a base number of people to join before the coupon is activated. This model introduces uncertainty on whether the coupon will ultimately be used. In many cases, it requires a significant amount of synchronous social communication and coordination to form a suitable collective buying group. Again, the opportunity cost in this couponing model is expensive.

### BRIEF SUMMARY OF INVENTION

The two fundamental keys for the present invention are collective buying power and the contract. Collective buying power is the mechanism that will minimize costs for both the party receiving the good or service (participant) and the party providing the good or service (merchant). The contract is the mechanism that will structure the market to create the buying collective and the incentive to invite additional participant to join the collective. It will also provide all market participants the same price per unit at a discrete moment in time. Meaning that while prices of contracts may fluctuate, the fluctuation will return the best possible outcome for each user, both at a discrete moment and summed over the life of the contract.

There are a few outcomes of the present invention that decrease the inefficiencies of current markets and particularly couponing models. Market participants are provided a real monetary incentive to share and recruit additional market participants. New participants joining take advantage of the prevailing group's collective buying power. Merchants gain access to a large market of participants that is also a steady and defined stream. The model is also sustainable over an infinite period of time instead of a one-time offer. Moreover, the contract takes uncoordinated individual entities and structures them into a larger, coordinated collective.

### DETAILED DESCRIPTION

A market is a system of multiple participants (parties) who engage in exchange based on a prevailing structure. A party is an entity that can enter into an agreement. In this present invention, a new structure will be defined that will increase the efficiencies of prevailing market structures and introduce a new market type.

The contract will be the mechanism that provides the de-facto structure for the market. A contract is a written or spoken agreement that is intended to be enforceable and has the minimum characteristics:
1.) The contract has a price, p.
2.) The contract is defined for a time of period x.
3.) x is further divided into y number of periods.
4.) y must be greater than 0.
5.) For each y period, the holder of the contract will receive an order, o, of z number of item(s) or service(s) on a particular datetime.
6.) z must be greater than 0.
7.) A symbol, typically a mathematical equation, which represents the collective buying power of a contract given z number of item(s) concurrently under contract given discrete references in time and a corresponding price.
8.) When the contract is fulfilled, the holder of the contract will have received y*z number of items or services. To adhere to the homogeneous condition for perfect competition, similar contracts within the market will have similar x, y and z conditions. Variable contractual duration may exist through secondary markets and their emergence cannot be ignored. However, the present invention limits the need as at any given moment in time, a participant receives the same volume discount at the same moment in time regardless of the date entered into the contract. Moreover, the type of discount provided, linear, quadratic or some other function, can vary. It is also worth noting that the participant could receive all the items at the beginning of the contract; however, an order fulfillment date based on the period must be necessarily generated to provide a change in volume over the life of the contract, reflecting the exiting of the contract from the market.

Parties become participants in the market by entering into and interacting with a contract. The market exchanges the above-mentioned contracts and produces desirable outcomes that permit stakeholders to collectively buy without coordination or concern for time, volume and price fluctuations, or the degree of collective buying power. To examine the benefits, equations will be presented to describe the market outcomes. The present invention does not make the case that these equations are the only mathematical representation of the market. Rather, they serve to demonstrate the value of and processes necessary to utilize the present invention.

In a market, a party must engage in an exchange. In the present invention, a market participant purchases the contract at an initial price, referred to hereafter as the prevailing price, and in return receives fulfillment of the contract as per the terms. The prevailing price is the price from the current date and time until the end of the contract at a future date and reflects the total volume of the collective from the current date to the end date. Volume at a current time can fluctuate as parties choose either to enter a new contract or exit by not renewing. Because collective buying power is necessary for the present invention, price and volume are in an inverse relationship. As a result, the price of the contract can increase or decrease.

Once a party enters the contract, the prevailing price quoted becomes a reference point, referred to hereafter as the prevailing contract price. Just like the prevailing price, a prevailing contract price is calculated from the collective volume; however, the volume quoted is from the start to the end of the contract. As a result, the volume of the contract can increase as other parties enter but cannot decrease because parties cannot exit as per the contract. With the contract providing structure and collective buying power forcing the price movements, the price of a participant's contract can only decrease or remain the same over time.

Examining the structure through equations, a standard prevailing price can be represented as:

pp=yz(p−d)

where pp is the prevailing price, y is the number of periods in the contract, z is the total number of items per period, p is the price per item and d is the discount.

A standard discount due to the collective buying power can be represented as:

dₓ=\sqrt{x}

where dₓ is the instant discount for x the total number of items per order contracted and x greater than 1.

The total discount for x the total number of items is:

$${td}_{x} = \int \sqrt{x} = \frac{2 {x}^{3 / 2}}{3}$$

where tdₓ is the total discount of a contract for x the total number of items per order contracted.

Equating the discount on all items equally yields:

$$d = \frac{2 \sqrt{x}}{3}$$

A standard prevailing price for x number of items can be represented as:

$${pp}_{x} = yzp ( 1 - \frac{2 \sqrt{x}}{3} )$$

where ppₓ is the prevailing price for x total number of item for the entire number of participants, y is the number of periods in the contract, z is the total number of items per period, p is the price per item and d is the discount.

x, the total volume, can be represented as:

$$x = z {\sum }_{i}^{n} {O}_{i}$$

where x is the total volume, z is the total number of items per period, i is the initial datetime, n is the ending datetime, and oᵢ is the number of orders at i.

The standard price for quoting a contract given time interval can be represented as:

$${pp}_{in} = yzp ( 1 - \frac{2 \sqrt{z {\sum }_{i}^{n} {O}_{i}}}{3} )$$

where ppᵢₙ is the price for the datetime i to n, y is the number of periods in the contract, z is the total number of items per period, p is the price per item, z is the total number of items per period, i is the initial datetime, n is the ending datetime, and oᵢ is the number of orders at i.

The present invention creates improved outcomes for market participants. First, at any given moment in time, the discount received reflects the best possible price for the collective at the given volume amount. This decreases uncertainty because a participant does not need to worry about waiting and buying at a lower price in the future. Moreover, the present invention limits the uncertainty of the future by calculating prices for the future and tying them to the present price of the contract. As is evident above, if the participant is in the contract, the added volume in the future is captured in the quoted discount. Buying for multiple periods will also prevent a whiplash of price increases. The only way to exit is by allowing the contract to lapse. In exiting, the volume of the collective will gradually decrease as one order after another is fulfilled and escapes the collective volume calculation. As a result, the volume of the collective at the current datetime will decrease slowly. The structure of the market also provides incentives for individuals to invite and market the contract. After all, increasing the collective buying power also increases the discount. If the discount increases for a contract, the participants will be credited the difference. This incentive also compensates for the limit of choices which participants face once in a contract. Moreover, neither does the invitee receive less not the inviter more of a discount because the calculated discount is the instance of the buying collective volume at that moment in time given the volume over the life of the contract. As a result, the interests of all participants overlap.

The market structure also provides benefits for the merchant and/or manufacturer. They have access to a steady stream of consumers, predictable over a longer run, which can only decline slowly over time. As a result, merchants can predict the future more accurately, providing the ability to allocate capital more efficiently with a better understanding of cash flow.

1. A system comprising: one or more participants who interact and exchange for economic benefit with a contract that is fulfilled by some party. Participants are free to exchange or not to exchange information to any party, both inside and outside of the system.

2. The system of claim 1 wherein the contract comprises the following: The contract is defined for a time of period x. x is further divided into y number of periods. y must be greater than 0. For each y period, the holder of the contract will receive an order, o, at a datetime within period y of z number of item(s) or service(s). z must be greater than 0. A symbol, typically a mathematical equation, which represents the collective buying power of a contract given z number of item(s) or service(s) concurrently under contract within the system of claim 1 given discrete references in time and a corresponding price. When the contract is fulfilled, the holder of the contract will have received y*z number of items or services and a representation of the collective buying power of the contract.

3. The system of claim 1 wherein economic benefits are present to buying in larger volumes than in smaller. More generally, participant(s) in the system can exercise collective buying power.

4. The system of claim 1 wherein the economics benefits are awarded to a participant based on the total volume of items whose order fulfillment date occurs during the lifetime of the participant's contract.

5. The system of claim 1 wherein the contract of claim 2 can be fulfilled at anytime. Regardless of the date of actual fulfillment, the contract order date is the reference point for the number of items when calculating the collective volume and collective buying power over a given time interval.

6. The system of claim 1 wherein any additional economic benefit resulting from the increase of the volume during the lifetime of a participant's contract not already accounted for is returned back to the participant to reflect the present value of the collective buying power.
